(19) United States
(12) Patent Application Publication
(10) Pub. No.: US 2005/0034138 A1
(43) Pub. Date: Feb. 10, 2005

(54) Emergency eject-level apparatus for optical disk drive

(75) Inventor: Zhu Yong, SuChou City (CN)

Correspondence Address: BRUCE H. TROXELL;SUITE 1404, 5205 LEESBURG PIKE, FALLS CHURCH, VA, 22041, US

(73) Assignee: BENQ Corporation

(21) Appl. No.: 10/910,277

(22) Filed: Aug. 4, 2004

(30) Foreign Application Priority Data
Aug. 8, 2003 (TW) 92214381

(51) Int. Cl. G11B 33/02

(52) U.S. Cl. 720/609

(57) ABSTRACT

The eject-level apparatus of the present invention comprises: a base having a fixing axle, an elastic column, and an eject-level arranged thereon. The fixing axle is protruding from the surface of the base by a first specific height, and the free end thereof is arranged with a bulging inset key. The elastic column is protruding from the surface of the base by a second specific height and is being fixed onto the base by an elastic means such that the elastic column is capable of performing a limited upward/downward displacement by depressing the top of the same. The eject-level has a bottom, a pivot hole and a notch formed inside the pivot hole. The shapes and sizes of both the pivot hole and the notch are formed corresponding to those of the fixing axle and the inset key such that when the eject-level is at a specific dismantle position, the notch is just aligned with the bulging inset key and the top of the elastic column is just abutted against the bottom of the eject-level.

### FIELD OF THE INVENTION

The present invention relates to an eject-level apparatus for a disk drive, and more particularly, to an eject-level apparatus for an optical disk drive.

### BACKGROUND OF THE INVENTION

In a few short years, the optical disk drive has gone from pricey luxury to inexpensive necessity on the modern PC, e.g. CD-ROM, etc. The CD-ROM has opened up new computing vistas that were never possible before, due to its high capacity and broad applicability. In many ways, the CD-ROM has replaced the floppy disk drive. CD-ROM drives come in different speeds. The speed is denoted in terms of how much faster it is than a standard audio CD player. Therefore a 2× drive is twice the speed of your stereo's CD player, and so on. Technology has advanced quite a bit to meet with the speed-up requirement of data access. Today, 24×, 32× all the way up to near 50× or even 64× is quite common. The larger the memory is, the more audio/video data it can store, and thus the faster the access speed of the storage media is the better. In this regard, CD-ROM drives are included in just about every PC on the market today.

While a PC is operating normal, the power supply of the PC will provide power to the optical disk drive installed therein such that the optical disk drive can operate normally. Thus, when an user of the PC intends to remove the optical disk from the optical disk drive, he can simply press the eject button at the front panel thereof and then the disc tray thereof will be eject for the user to take out the optical disk therein.

However, when the PC is off, the optical disk can not be removed simply by pressing the ejection button, but the process of removal need to be carried out manually. Conventionally, most optical disk drives are equipped with an eject-level therein for driving an ejection apparatus to eject the disc tray. The eject level is being fixed inside an ejection mechanism of the optical disk drive using at least a screw. The above conventional method is inconvenient to implement since it uses at least one additional screw for fixing the eject-level and requires to tighten the screw by rotating the same.

### SUMMARY OF THE INVENTION

The primary object of the invention is to provide an eject-level apparatus for optical disk drive for fixing the eject-level of the optical disk drive.

To achieve the aforementioned object, the eject-level apparatus of the present invention comprises: a base having a fixing axle, an elastic column, and an eject-level arranged thereon.

The fixing axle is protruding from the surface of the base by a first specific height, and the free end thereof is arranged with a bulging inset key. The elastic column is protruding from the surface of the base by a second specific height and is being fixed onto the base by an elastic means such that the elastic column is capable of performing a limited upward/downward displacement by depressing the top of the same.

The eject-level has a bottom, a pivot hole and a notch formed inside the pivot hole. The shapes and sizes of both the pivot hole and the notch are formed corresponding to those of the fixing axle and the inset key such that when the eject-level is at a specific dismantle position, the notch is just aligned with the bulging inset key and the top of the elastic column is just abutted against the bottom of the eject-level.

Following drawings are cooperated to describe the detailed structure and its connective relationship according to the invention for facilitating your esteemed members of reviewing committee in understanding the characteristics and the objectives of the invention.

### BRIEF DESCRIPTION OF THE DRAWINGS

FIG. 1 is a top view of an emergency eject-level apparatus for optical disk drive according to the present invention.

FIG. 2 is an enlarge diagram of the B area of FIG. 1.

FIG. 3A is a top view showing an emergency eject-level apparatus for optical disk drive at the dismantle position.

FIG. 3B to FIG. 3D shows the continuing operation of an emergency eject-level apparatus for optical disk drive of the present invention.

FIG. 4 is a diagram depicting an elastic column of an emergency eject-level apparatus for optical disk drive according to a preferred embodiment of the present invention.

### DESCRIPTION OF THE PREFERRED EMBODIMENT

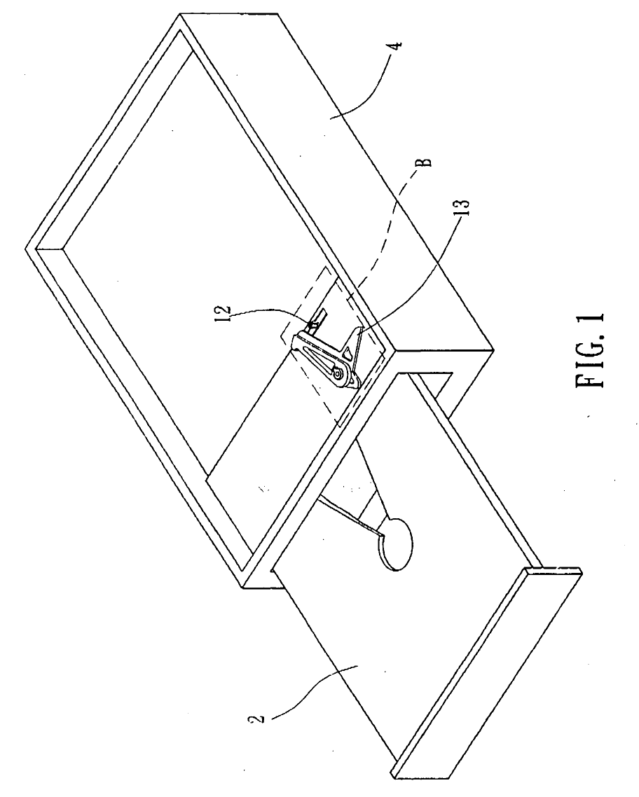

Please refer to FIG. 1 for a preferred embodiment of an emergency eject-level apparatus for optical disk drive according to the present invention. As seen in FIG. 1, the optical disk drive 4 comprises a disc tray 2 for carrying an optical media. The disc tray 2 capable of sliding in and out the optical disk drive 4 is driven to slide by an emergency ejection mechanism B driven by an external force applying on an eject-level 13 thereof.

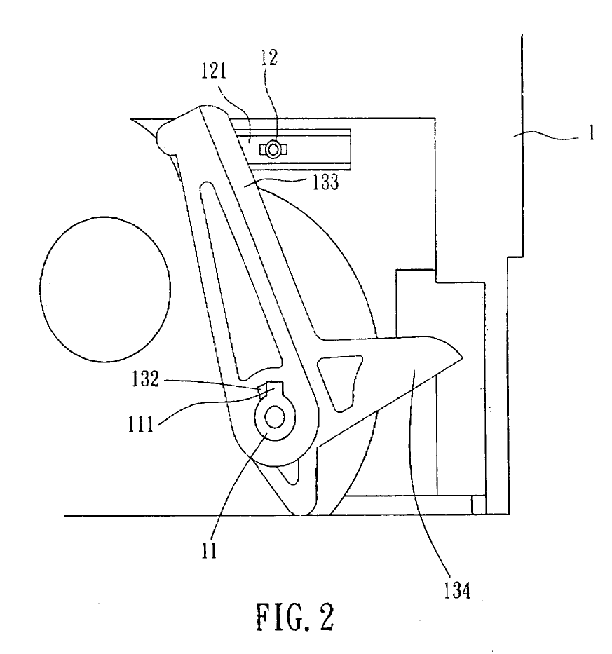

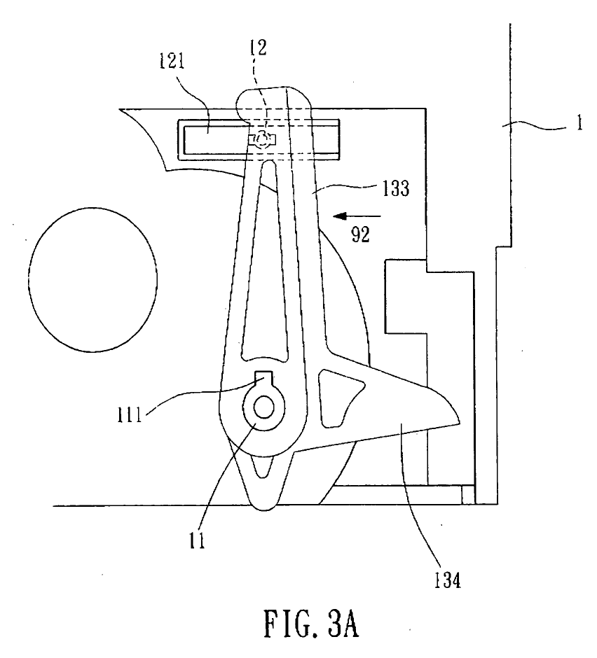

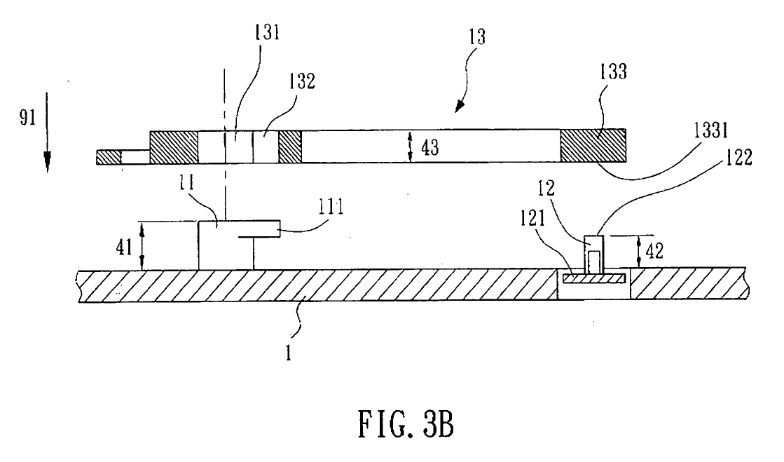

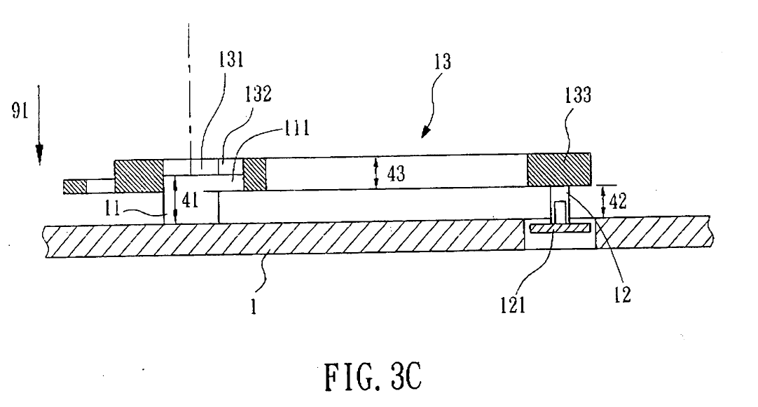

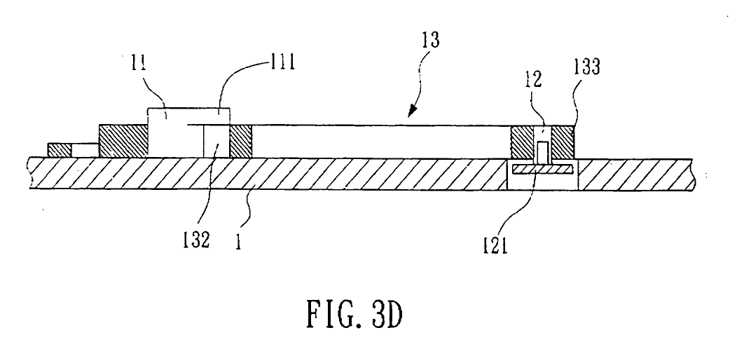

In the present preferred embodiment with reference to FIG. 2, and FIG. 3A˜FIG. 3D, the emergency eject-level apparatus comprises: a base 1, having a fixing axle 11, an elastic column 12 and an eject-level arranged thereon. Moreover, the base 1 can be one of the inner surface of the optical disk drive 4 and the fixing axle 11 is protruding from the base 1 by a first specific height 41, and the free end thereof is arranged with a bulging inset key 111.

The elastic column 12 has a top 122 and is connect to a reed 121 disposed on the base 1. The reed 121 is a flexible plate extending horizontal along the base 1, having a fix end being fixed onto the base 1 and a free end capable of oscillating up and down by subjecting to an external force. The elastic column 12 is protruding from the surface of the base 1 by a second specific height 42 and is capable of performing a limited upward/downward displacement according to the magnitude of the external depressing force.

The thickness 43 of the eject-level 13 is slightly smaller than the first specific height 41 such that the fixing axle 11 can be inset into the eject-level 13 and thus is able to revolve around the fixing axle 11.

In the preferred embodiment, the difference between the first specific height 41 and the second specific height is slightly smaller than the thickness 43.

The eject-level 13 comprises an applying arm 134, a driving arm 133 and a bottom 1331. A specific included angle is formed between the applying arm 134 and the driving arm 133, and a pivot hole 131 is further formed at the joint of the applying arm 134 and the driving arm 133 having a notch 132 formed therein. The shapes and sizes of both the pivot hole 131 and the notch 132 are formed corresponding to those of the fixing axle 11 and the inset key 111.

When the eject-level 13 is at a specific dismantle position, the notch 132 is just aligned with the bulging inset key 111 such that the inset key 111 can fit into the notch 132 for enabling the fixing axle 11 to inset into the pivot hole 131 following a first direction 91.

While fixing the eject-level 13 on the fixing axle 11, the bottom 1331 of the eject-level 13 is just abutted against the top 122 of the elastic column 12 causing the elastic column 12 to have a downward movement by subjecting to a pressing force in the first direction 91. After insetting the fixing axle 11 into the eject-level 13, the eject-level 13 use the fixing axle as axis to rotate an predefined angle following the second direction 92 for enabling the eject-level 13 to be fixed onto the fixing axle 11, and the same time, the eject-level is not at the dismantle position such that the elastic column 12 will resume the height of the second specific height 42 without subjecting to an external force and therefore will interfere with the movement of the eject-level 13 for preventing the same from rotating to the dismantle position. In this regard, the eject-level 13 can be fixed onto the fixing axle 11 utilizing the structure of the inset key 111 and the fixing axle 11.

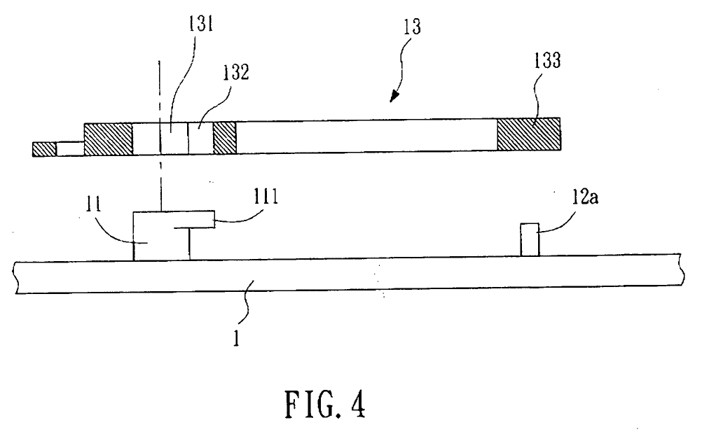

Please refer to FIG. 4 for another preferred embodiment of the elastic column according to the present invention. The elastic column 12a is a cylinder made of an elastic material. The elastic column 12a can be forced to move downward by pressing the same such that the eject-level 13 can be fixed onto the fixing axle 11 utilizing the structure of the inset key 111 and the fixing axle 11 which is similar to the above description.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. An emergency eject-level apparatus for a disk drive, comprising:
a base, further comprising:
a fixing axle, protruding from the surface of the base by a first specific height, and the free end thereof being arranged with a bulging inset key;
an elastic column, protruding from the surface of the base by a second specific height and being fixed onto the base by an elastic means for enabling the elastic column to perform a limited upward/downward displacement by depressing the same; and
an eject-level, having a pivot bole and a notch formed inside the pivot hole, wherein the shapes and sizes of both the pivot hole and the notch are formed corresponding to those of the fixing axle and the inset key such that when the eject-level is at a predefined dismantle position, the notch is just aligned with the bulging inset key for enabling the fixing axle to inset into the pivot hole and therefore pivotally fixing the eject-level onto the fixing axle.

2. The emergency eject-level apparatus for a disk drive of claim 1, wherein when the eject-level is at the dismantle position, the top of the elastic column is just abutted against the bottom of the eject-level.

3. The emergency eject-level apparatus for a disk drive of claim 1, wherein when the eject-level is being pivotally fixed onto the fixing axle and is not at the dismantle position, the movement of the eject-level is being interfered by the elastic column since the elastic column is not subjecting to an external pressing force.

4. The emergency eject-level apparatus for a disk drive of claim 1, wherein the eject-level comprises an applying arm and a driving arm, both extending horizontally outward from the pivot hole disposed at the joint of the two with a specific included angle being formed between the applying arm and the driving arm.

5. The emergency eject-level apparatus for a disk drive of claim 4, wherein the optical disk drive comprises a disc tray for carrying an optical media, and the disc tray capable of sliding in and out the optical disk drive is driven to slide by an emergency ejection mechanism driven by applying an external force on the applying arm of the eject-level pivotally fixed onto the fixing axle for driving the eject-level to revolve around the fixing axle.

6. The emergency eject-level apparatus for a disk drive of claim 4, wherein when the eject-level is at the dismantle position, the elastic column is against the driving arm.

7. The emergency eject-level apparatus for a disk drive of claim 1, wherein the elastic means is a reed disposed on the base.

8. The emergency eject-level apparatus for a disk drive of claim 1, wherein the reed and the elastic column are all-in-one formed on the base.

9. The emergency eject-level apparatus for a disk drive of claim 7, wherein the reed is a flexible plate extending horizontal along the base, having a fix end being fixed onto the base and a free end capable of oscillating upward and downward.

10. An emergency eject-level apparatus for a disk drive, comprising:
a base, further comprising:
a fixing axle, protruding from the surface of the base by a first specific height, and the free end thereof being arranged with a bulging inset key;
an elastic column, protruding from the surface of the base by a second specific height and being fixed onto the base by an elastic means for enabling the elastic column to perform a limited upward/downward displacement by depressing the same; and
an eject-level, having a bottom, a pivot hole and a notch formed inside the pivot hole, wherein the shapes and sizes of both the pivot hole and the notch are formed corresponding to those of the fixing axle and the inset key such that when the eject-level is at a predefined dismantle position, the notch is just aligned with the bulging inset key and the top of the elastic column is just abutted against the bottom of the eject-level.

11. The emergency eject-level apparatus for a disk drive of claim 10, wherein the eject-level comprises an applying arm and a driving arm, both extending horizontally outward from the pivot hole disposed at the joint of the two with a specific included angle being formed between the applying arm and the driving arm.

12. The emergency eject-level apparatus for a disk drive of claim 11, wherein the optical disk drive comprises a disc tray for carrying an optical media, and the disc tray capable of sliding in and out the optical disk drive is driven to slide by an emergency ejection mechanism driven by applying an external force on the applying arm of the eject-level pivotally fixed onto the fixing axle for driving the eject-level to revolve around the fixing axle.

13. The emergency eject-level apparatus for a disk drive of claim 11, wherein when the eject-level is at the dismantle position, the elastic column is against the driving arm.

14. The emergency eject-level apparatus for a disk drive of claim 10, wherein the elastic means is a reed disposed on the base.

15. The emergency eject-level apparatus for a disk drive of claim 14, wherein the reed and the elastic column are all-in-one formed on the base.

16. The emergency eject-level apparatus for a disk drive of claim 14, wherein the reed is a flexible plate extending horizontal along the base, having a fix end being fixed onto the base and a free end capable of oscillating upward and downward.

17. The emergency eject-level apparatus for a disk drive of claim 10, wherein when the eject-level is at the dismantle position, the elastic column is just against the eject-level causing the inset key of the fixing axle to fit into the notch of the pivot hole that enables the elastic column to be pressed downward.

18. The emergency eject-level apparatus for a disk drive of claim 10, wherein when the eject-level is fixed onto the fixing axle and is not at the dismantle position, the elastic column 12 without subjecting to an external pressing force and therefore interferes with the movement of the eject-level for preventing the same from rotating to the dismantle position.
